(19) United States
(12) Patent Application Publication
(10) Pub. No.: US 2017/0140273 A1
(43) Pub. Date: May 18, 2017

(54) SYSTEM AND METHOD FOR AUTOMATIC SELECTION OF DEEP LEARNING ARCHITECTURE

(71) Applicant: VIDEO INFORM LTD, Petach Tikva (IL)

(72) Inventors: Yoram SAGHER, Hod Hasharon (IL); Moshe BUTMAN, Petah Tikva (IL); Ronen SAGGIR, Rishon Letzion (IL); Rani AMAR, Givat Shmuel (IL); Lahav YEFFET, Rehovot (IL)

(21) Appl. No.: 15/353,784

(22) Filed: Nov. 17, 2016

Related U.S. Application Data
(60) Provisional application No. 62/256,722, filed on Nov. 18, 2015.

(51) Int. Cl. G06N 3/08; G06N 3/04

(52) U.S. Cl. CPC G06N 3/082; G06N 3/04

(57) ABSTRACT

A system and method of determining a neural network configuration may include receiving at least one neural network configuration, altering the received configuration for at least two iterations, calculating a first parameter of an altered configuration, calculating a second parameter of a consecutive altered configuration of the at least two iterations, comparing values of the calculated first parameter and second parameter, and determining a configuration having largest value of the calculated parameters.

### CROSS REFERENCE TO RELATED APPLICATION

This application claims the benefit of U.S. Provisional Patent Application 62/256,722 filed on Nov. 18, 2015 entitled “AUTOMATING SELECTION OF DEEP LEARNING ARCHITECTURE”, incorporated herein by reference in its entirety.

### FIELD OF THE INVENTION

The present invention relates to deep learning architectures of computer systems. More particularly, the present invention relates to systems and methods for automatic selection of deep learning architectures.

### BACKGROUND OF THE INVENTION

Object or pattern detection techniques are usually based on a supervised learning machine methods, for instance detecting an object and/or pattern in a signal (e.g., with voice recognition). In a classic supervised learning scheme, the learning machine (e.g., a computer) is fed with labeled examples to create a specific object detection algorithm (or classifier) predicting the correct output value for any valid input. For instance, a labeled example can be a pair of inputs representing the object and a corresponding desired output (provided by the supervisor).

In recent years, the leading scheme and architecture for solving special purpose detection problems is to use deep neural networks (DNNs). Design of neural network (NN) architecture (and particularly for deep neural networks) may be complicated and time consuming. Difficulties in finding the best deep network architecture include the large number of the parameters that are involved. Unlike many other machine learning algorithms which can be used as a “black box” (usually small number of parameters to decide on), deep neural networks define only a general architecture and not an exact configuration.

Various parameters that affect the network performance may be composed, for example, by one or more of parameters such as: number of hidden layers (not input or output layers), number of neurons at each layer, activation function at each neuron, convolutional NN and/or “fully connected” and/or combination of both, pooling method at each layer, normalization method, stride, input layer size, weights initializations, etc. Changes in one or more of the above (or other) configuration parameters considerably affect the detection performance. Since the design of a deep neural network for a specific problem is a complex and “Sisyphean” work due to the numerous possible combinations, various design heuristics have been developed for designing the hidden layers, which help getting the desired output.

Current architecture selection is carried out manually and is followed by a performance evaluation process to find the best combination for the network. Thus, a full process of training and developing an object detection algorithm using deep neural networks could be very tedious and time consuming. If several learning algorithms are employed then the complexity of the architecture increases substantially.

### SUMMARY OF THE INVENTION

There is thus provided, in accordance with some embodiments of the invention, a method of determining a neural network configuration, the method including receiving, by a processor, at least one neural network configuration, altering, by the processor, the received configuration for at least two iterations, calculating, by the processor, a first parameter of the altered configuration, calculating, by the processor, a second parameter of a consecutive altered configuration of the at least two iterations, comparing, by the processor, values of the calculated first parameter and second parameter, and determining, by the processor, a configuration having largest value of the calculated parameters. In some embodiments, the method further includes outputting the determined configuration.

In some embodiments, the determined configuration defines a neural network to carry out an object detection algorithm. In some embodiments, the method further includes receiving a set of labeled samples, performing evaluation of the received labeled samples with the object detection algorithm, and detecting an object from the set of labeled samples, with the object detection algorithm. In some embodiments, the configuration is determined to correspond with an object to be detected with the object detection algorithm. In some embodiments, the method further includes outputting the object detection algorithm.

In some embodiments, the parameter is selected from the group consisting of a receiver operating characteristic curve, a confusing matrix, real-time performance, a true-positives rate and a false-positive rate. In some embodiments, the altering is carried out randomly.

In some embodiments, the altering includes altering at least one of the group consisting of a hidden layer, a number of neurons at a layer, number of filters at each layer, type of network, an activation function at a neuron, convolutional neural network, composition, fully connected neural network composition, pooling method at a layer, normalization method, stride, input layer size, and weight initializations.

In some embodiments, at least one consecutive altered configuration of the at least two iterations is based on a configuration generated by a prior iteration, said configuration generated by said prior iteration having a largest value of said first parameter from prior iterations.

There is also provided, in accordance with some embodiments of the invention, a system for determining a neural network configuration, the system including a processor, configured to alter neural network configurations, a memory module, coupled to the processor, and a configuration database, coupled to the processor and configured to store neural network configurations. In some embodiments, the processor is further configured to calculate parameters for each alteration of neural network configurations stored on the configuration database.

In some embodiments, the memory module is configured to store a received set of labeled samples. In some embodiments, the system further includes an object database coupled to the processor and configured to provide input of objects therefor.

In some embodiments, the system further includes at least one detector coupled to the processor and configured to detect objects. In some embodiments, the alteration of neural network configurations corresponds to objects detected by the at least one detector.

There is also provided, in accordance with some embodiments of the invention, a method of determining a neural network configuration, the method including altering, by a processor, at least one neural network configuration, calculating, by the processor, a first parameter of the altered configuration, calculating, by the processor, a second parameter of different altered configuration, comparing, by the processor, values of the calculated first parameter and second parameter, and determining, by the processor, a configuration having largest value of the calculated parameters.

In some embodiments, the determined configuration defines a neural network to carry out an object detection algorithm. In some embodiments, the method further includes receiving a set of labeled samples, performing evaluation of the received labeled samples with the object detection algorithm, and detecting an object from the set of labeled samples, with the object detection algorithm.

In some embodiments, the configuration is determined to correspond with an object to be detected with the object detection algorithm. In some embodiments, the altering is carried out randomly.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, can be understood by reference to the following detailed description when read with the accompanying drawings in which:

FIG. 1 shows a block diagram of an exemplary computing device, according to an embodiment of the present invention;

FIG. 2A shows a block diagram of a configuration selection system, according to an embodiment of the present invention;

FIG. 2B schematically illustrates an example of a neural network configuration, according to an embodiment of the present invention;

FIG. 3 shows a flow chart for automatic selection of deep neural network configurations, according to an embodiment of the present invention; and

FIG. 4 shows a flow chart for a method of automatically determining neural network configurations, according to an embodiment of the present invention.

It will be appreciated that for simplicity and clarity of illustration, elements shown in the figures have not necessarily been drawn to scale. For example, the dimensions of some of the elements can be exaggerated relative to other elements for clarity, or several physical components may be included in one functional block or element. Further, where considered appropriate, reference numerals can be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention can be practiced without these specific details. In other instances, well-known methods, procedures, and components have not been described in detail so as not to obscure the present invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently.

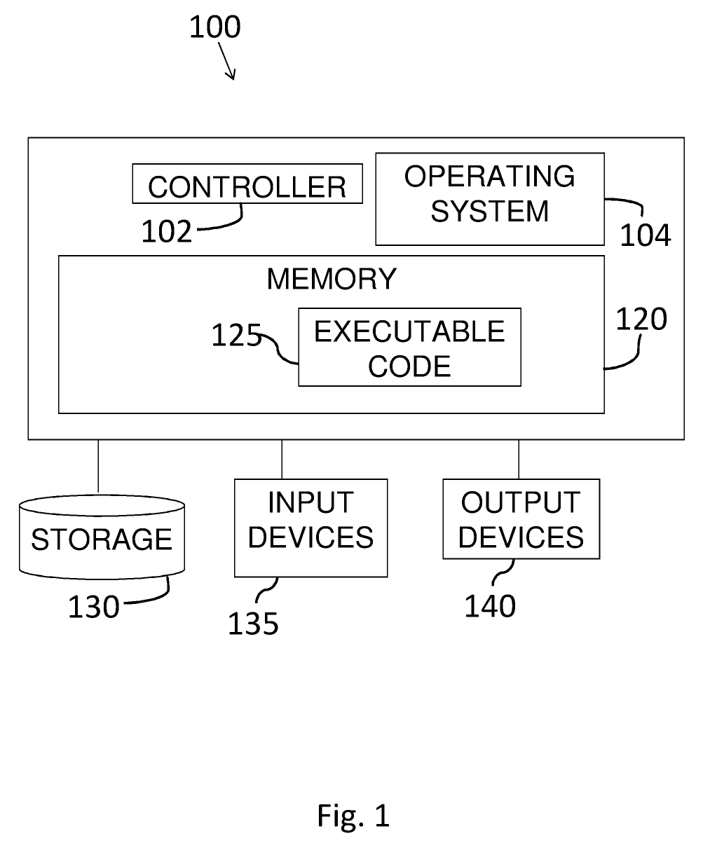

Reference is now made to FIG. 1, which shows a block diagram of an exemplary computing device 100, according to some embodiments of the invention. Computing device 100 may include a controller 102 that may be, for example, a central processing unit processor (CPU), a chip or any suitable computing or computational device, an operating system 104, a memory 120, a storage 130, at least one input device 135 and at least one output devices 140. Controller 102 may be configured to carry out methods as disclosed herein by for example executing code or software.

Operating system 104 may be or may include any code segment designed and/or configured to perform tasks involving coordination, scheduling, arbitration, supervising, controlling or otherwise managing operation of computing device 100, for example, scheduling execution of programs. Operating system 104 may be a commercial operating system. Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 20 may be or may include a plurality of, possibly different memory units.

Executable code 125 may be any executable code, e.g., an application, a program, a process, task or script. Executable code 125 may be executed by controller 102 possibly under control of operating system 104. For example, executable code 125 may be an application for image classification. In some embodiments, more than one computing device 100 may be used. For example, a plurality of computing devices that include components similar to those included in computing device 100 may be connected to a network and used as a system.

Storage 130 may be or may include, for example, a hard disk drive, a floppy disk drive, a Compact Disk (CD) drive, a CD-Recordable (CD-R) drive, a universal serial bus (USB) device or other suitable removable and/or fixed storage unit. Content may be stored in storage 130 and may be loaded from storage 130 into memory 120 where it may be processed by controller 102. In some embodiments, some of the components shown in FIG. 1 may be omitted. For example, memory 120 may be a non-volatile memory having the storage capacity of storage 130. Accordingly, although shown as a separate component, storage 130 may be embedded or included in memory 120.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays, speakers and/or any other suitable output devices. It will be recognized that any suitable number of output devices may be operatively connected to computing device 100 as shown by block 140. Any applicable input/output (I/O) devices may be connected to computing device 100 as shown by blocks 135 and 140. For example, a wired or wireless network interface card (NIC), a modem, printer or facsimile machine, a universal serial bus (USB) device or external hard drive may be included in input devices 135 and/or output devices 140.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, a storage medium such as memory 120, computer-executable instructions such as executable code 125 and a controller such as controller 102.

The non-transitory storage medium may include, but is not limited to, any type of disk including floppy disks, optical disks, compact disk read-only memories (CD-ROMs), rewritable compact disk (CD-RWs), and magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices.

A system according to embodiments of the invention may include components such as, but not limited to, a plurality of central processing units (CPU) or any other suitable multi-purpose or specific processors or controllers, a plurality of input units, a plurality of output units, a plurality of memory units, and a plurality of storage units. A system may additionally include other suitable hardware components and/or software components. In some embodiments, a system may include or may be, for example, a personal computer, a desktop computer, a mobile computer, a laptop computer, a notebook computer, a terminal, a workstation, a server computer, a Personal Digital Assistant (PDA) device, a tablet computer, a network device, or any other suitable computing device. Unless explicitly stated, the method embodiments described herein are not constrained to a particular order or sequence. Additionally, some of the described method embodiments or elements thereof can occur or be performed at the same point in time.

As used hereinafter, the term ‘sample set’ may, in addition to its regular meaning, include one or more images, videos, audio recordings, matter-samples such as biologic (cells, tissues, viruses, etc.) matter, or molecular (DNA strings, crystal formations, etc.) compositions that may include a recognizable or determinable factor, element, characteristic or object. For example, a sample set may include a group of images, some of which may show and/or mark a car.

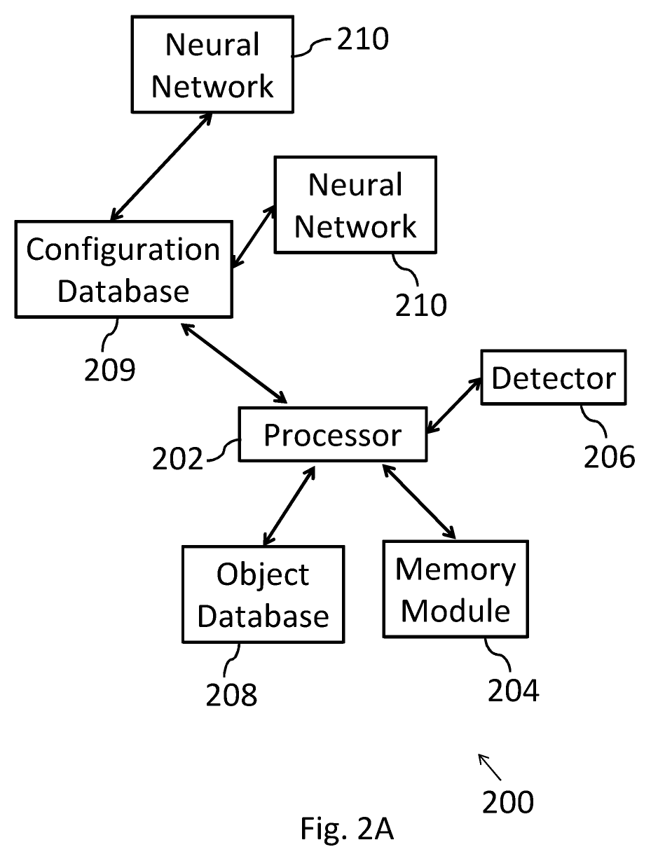

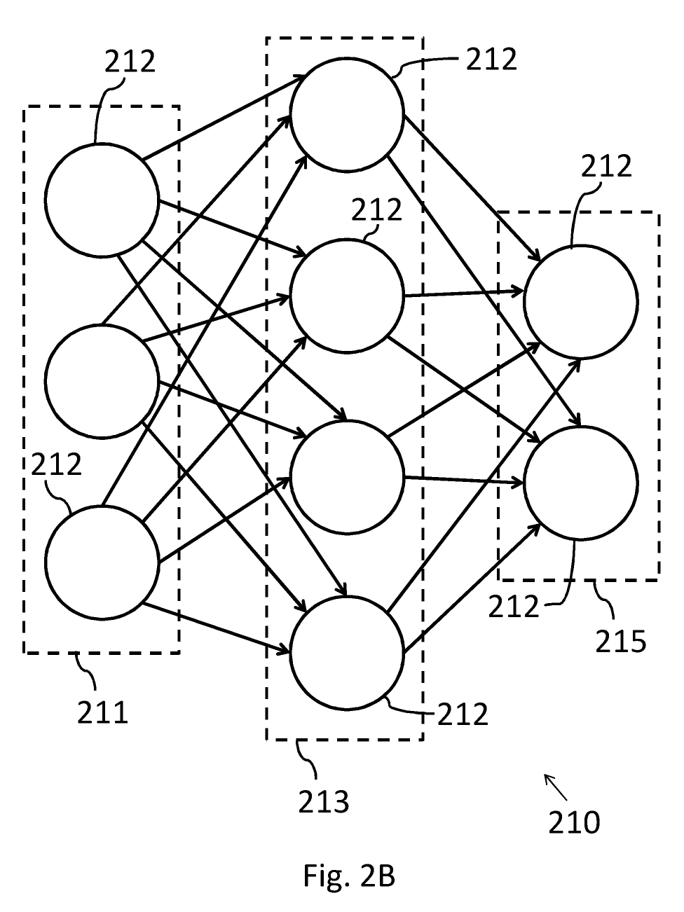

Reference is now made to FIG. 2A, which shows a block diagram of a configuration selection system 200, according to some embodiments of the invention. The direction of arrows in FIG. 2 may indicate the direction of data flow. An example of a configuration of a neural network is shown in FIG. 2B.

System 200 may include at least one processor 202 (e.g., such as a computer system as shown in FIG. 1), that may run an executable code and be coupled to input and/or output devices. In some embodiments, processor 202 may include at least one memory module 204 configured to store data thereon.

In some embodiments, processor 202 may include at least one detector 206, where the detector 206 may detect optical parameters such as pixels, objects, colors (e.g., with an imager) and/or other parameters such as audio signals. The at least one detector 206 may be coupled to the at least one memory module 204 in order to allow storage of data (e.g., an image or an audio signal) detected by the detector 206.

According to some embodiments, processor 202 may include at least one object database 208 configured to provide input of objects for processor 202. For example, object database 208 may include a database of labeled objects such as images (or audio signals) to be provided as input for processor 202.

According to some embodiments, the at least one processor 202 may implement a configuration selection algorithm for speeding up and/or facilitating and/or optimizing and/or automating the selection of at least one deep neural network (DNN) 210 configuration in order to allow object detection. A configuration of a neural network 210 may include particular connections between layers and/or nodes of the neural network 210, and once these connections are created the neural network 210 may be operable. A change in at least one connection between layers and/or nodes may create a different configuration of the neural network 210, for example removing an unnecessary connection between two nodes may reduce data flow between these nodes and thereby improve the overall data processing of the neural network 210 with the new configuration. In some embodiments, such an algorithm may iteratively and/or automatically optimize a deep learning architecture and configuration, for example to determine a detection algorithm that corresponds to one or more performance criteria, as further described hereinafter.

In some embodiments, existing hardware components may include at least one neural network 210 that is configured based on a selected configuration received from configuration database 209.

It should be noted that performance representation of a special purpose detection system and/or algorithm may be illustrated using a receiver operating characteristic (ROC) curve or using a classifier (or confusing) matrix, e.g. by calculating the accuracy of the algorithm. An ROC curve may be created by plotting the detection rate versus the false positives (for incorrect detections) rate at various threshold settings of the algorithm. The user (e.g., an algorithm developer) may not have a direct indication of whether the performance was really improved unless the ROC curves of the algorithms are calculated.

Other performance criteria parameters (such as processing time etc.) may also be calculated and measured in order to allow determination of the efficiency of the detection algorithm. A user may define or set as a goal, one or more criteria, parameters or efficiency levels that are to be reached by a detection algorithm in finding or detecting objects from a set of samples such as images, audio recordings or other collections of data.

Reference is now made to FIG. 2B, which schematically illustrates an example of a neural network 210 which may be defined by a configuration of configuration database 209, according to some embodiments of the invention. Neural network 210 may include an input layer 211 with at least one node 212 and an output layer 215 with at least one node 212. In some embodiments, at least one hidden layer 213 (with at least one node 212) may be created between the input layer 211 and the output layer 215, such that data passes from input layer 211 to the output layer 215. In some embodiments, a method or a device (e.g., processor 202) may create a configuration (e.g., stored in configuration database 209) which may define a neural network. A neural network may be formed or altered based on the configuration: e.g., neural network 210 may organize itself based on a configuration or may be organized by e.g., processor 202 based on a configuration.

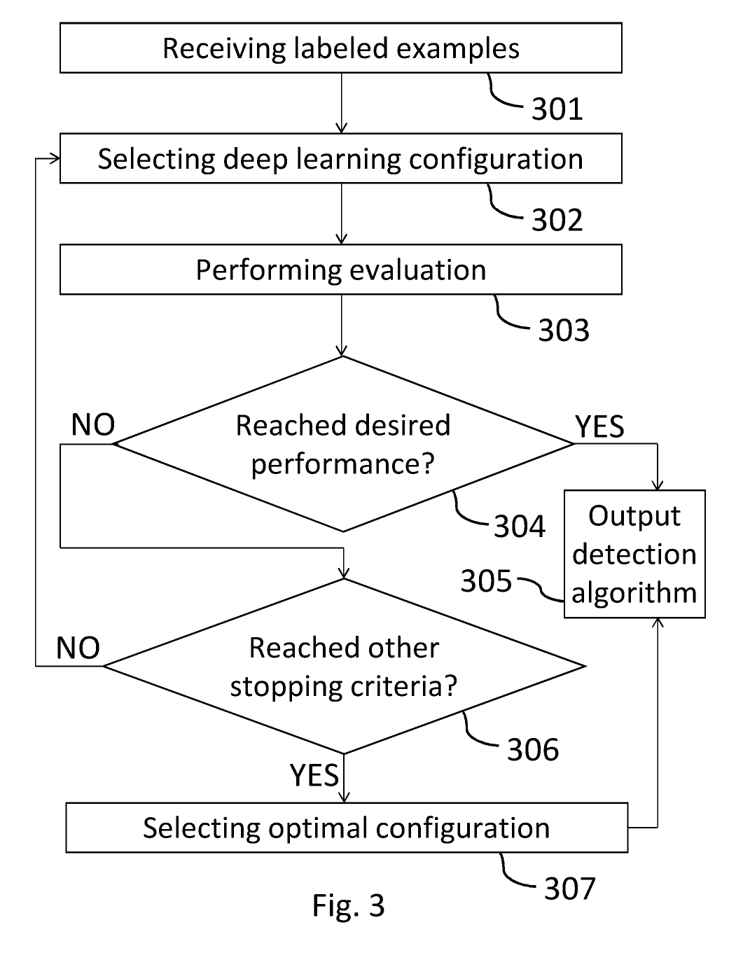

Reference is now made to FIG. 3, which shows a flow chart for automatic selection of deep neural network configurations, according to some embodiments of the invention. While an example set of hardware and systems are shown in FIGS. 1 and 2, other or different systems, different from those described in FIGS. 1 and 2, may perform methods as described herein. After labeled object samples are received 301, for instance from object database 208 (e.g., as shown in FIG. 2), processor 202 may execute code to select 302 a deep learning configuration based on predetermined attributes (e.g., based on processing time). In some embodiments, configuration selection 302 may be carried out randomly. As may be apparent to one of ordinary skill in the art, some known architecture configurations (e.g., from a configuration database) may also be selected.

In some embodiments, the selected 302 configuration may correspond to the received 301 labeled object samples. It should be noted that in order to reach an optimal configuration, the selected deep learning configurations may be iteratively, e.g. repetitively or in cycles, evaluated until the desired configuration is reached, where each iteration or cycle evaluates a different deep learning configuration. For example, a desired configuration may fulfill a performance requirement (e.g., processing time) and thereby create stopping criteria such that there is no need for further iterations. In some embodiments, criteria for reaching a desired level may be for example accuracy of the algorithm and/or the processing time and/or the combinations between detection rate and processing time.

In some embodiments, in at least one iteration (e.g., cycle of repetition) of the configuration selection 302, processor 202 may automatically select a specific deep neural network configuration, for instance to create a detection algorithm corresponding to the deep learning configuration. For example, specific (or predetermined) deep neural network configurations may be automatically generated and/or received from a deep neural network configuration database coupled to processor 202.

In some embodiments, the selected configuration may use a specific architecture (such as number of layers, number of neurons at each layer, number of filters, type of each layer (e.g. convolutional or fully), or other inputs) as may have been selected by a user or algorithm developer, and may automatically create in an iterative process at least one design (or configuration) of the deep learning network. It should be noted that each such design may be tested against one or more criteria (such as processing time, etc.), so as to allow measurement of the performance of these designs.

In some embodiments, processor 202 may automatically generate a plurality of designs (for instance stored on memory module 204) so as to allow comparing of the performance of each design to other generated designs, until an optimized design is determined. In some embodiments, each generated design (or configuration) may be stored on a dedicated configuration database 209.

In some embodiments, the optimized design may be selected as the detection algorithm to be implemented in evaluating a sample selection, such as a sample of images to detect an object in an image. The processor 202 may automatically perform evaluation 303 for performance of at least one of the stored configuration permutations (for instance stored on configuration database 209). For example, by computing the ROC curve with true-positives rate (e.g., percentage of true detection) versus false-positives rate curve or computing the accuracy (in the confusion matrix) on a test or validation set.

According to some embodiments, upon reaching a desired ROC curve and/or accuracy criterion, or other stopping criteria 304, the processor 202 may automatically run configuration selection iterations. The automatic configuration selection process may be executed, for instance using different feature extraction algorithms, with a different number of hidden layers, and/or number of neurons at each layer, and/or activation function at each neuron, and/or convolutional neural networks (NN)/fully connected/composition of both, and/or pooling method at each layer, and/or normalization algorithm, and/or stride, and/or input layer size, and/or weights initializations, as well as other parameters. At the output, processor 202 may output 305 an optimized configuration (for instance for a detection algorithm) determined therefrom. In some embodiments, at least one of the configuration selection iterations may be carried out automatically, by processor 202, in a random manner and/or in a deterministic manner. As may be apparent to one of ordinary skill in the art, some known architecture configurations (e.g., from a configuration database) may also be selected.

In some embodiments, at each iteration (e.g., series of operations in one cycle of repetition) of configuration selection, the processor 202 may automatically select a specific deep neural network configuration (for instance from dedicated configuration database 209) to create a new detection algorithm by selecting a subset of parameters from the large number of possible configuration parameters.

According to some embodiments, an optimized configuration may be determined automatically by running and measuring the numerous permutations against one or more parameters, and/or choosing a configuration that performs best under the relevant criteria such that an optimized detection algorithm may be reached. It should be appreciated that compared with conventional methods, an embodiment of the invention may allow for automatically created availability of a performance ROC prediction for the optimized detection algorithm with a prediction of processing time. An optimized neural network configuration may in some embodiments allow the processor 202 to operate with shorter processing time, for example while processing object detection algorithms. A determined configuration may define a neural network to carry out an algorithm such as an object detection algorithm.

In some embodiment, for at least one iteration of the configuration selection, the processor 202 may automatically select the specific deep neural parameter(s) to change according to and/or based on results of at least one previous iteration. For example, if in previous iterations, a changing of the pooling method achieved the best gain in the performance, the processor 202 may in a later permutation, use such information to select a later iteration architecture that uses such changed pooling method. In another example, if the algorithm, implemented on processor 202, found at one or more iterations that by using different normalization methods it achieves a large change in the performance, it may try testing at a subsequent iteration, a configuration relying on this knowledge.

In case that a desired performance has not been reached 304, processor 202 may check if other stopping criteria have been reached 306. If no other stopping criteria are detected, processor 202 may continue to a further iteration by selecting 302 a different deep learning configuration. In some embodiments, criteria for reaching a desired level may be for example accuracy of the algorithm and/or the processing time and/or the combinations between detection rate and processing time.

In some embodiments, an optimal configuration may be selected 307 (e.g., after a stopping criteria 306) with a set of validation and/or test examples. In some embodiments, a configuration may produce a predicted ROC and/or accuracy curve and a predicted real-time processing period for reaching such ROC, or other performance evaluation predictions according the user definitions. At the output, processor 202 may output 305 the selected optimized detection algorithm configuration determined therefrom.

In some embodiments, deep learning algorithm(s) may be combined as ‘weak classifiers’ to create a final algorithm. At a ‘boosting step’ an embodiment may automatically choose an optimized deep architecture that the system finds for the relevant ‘boosting iteration’.

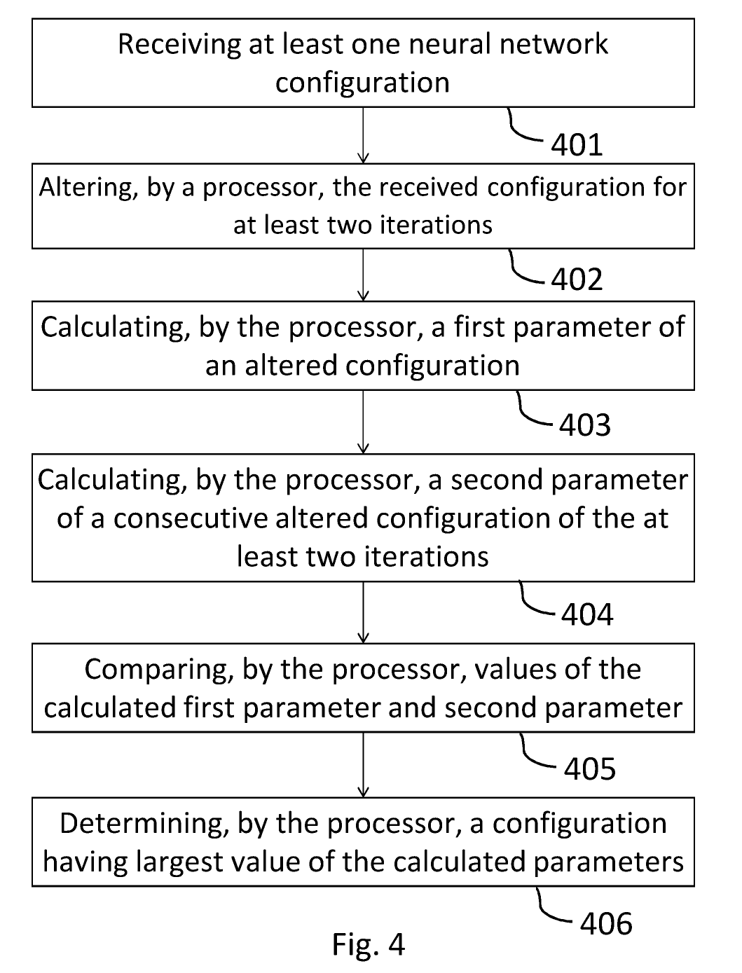

Reference is now made to FIG. 4, which shows a flow chart for a method of automatically determining neural network configurations, according to some embodiments of the invention. According to some embodiments, an embodiment may include for example processor 202 (other or different systems, different from those described in FIGS. 1 and 2, may perform methods as described herein) receiving 401 at least one neural network architecture configuration, for instance for a detection algorithm. For example, processor 202 may receive neural network architectures from dedicated configuration database 209. In some embodiments, receiving 401 the configuration may be from an input device, for instance inputted manually and/or by a processing unit.

According to some embodiments, an embodiment may further include processor 202 altering 402 the received configuration for at least two iterations. Some examples of configuration altering, may be adding hidden layers, using different type of a network (e.g. residual network), using different size of filters, etc. In some embodiments, altering 402 of the configuration may be carried out randomly.

According to some embodiments, the altering 402 may be carried out on a prior configuration that showed a predetermined value of the tested parameter (e.g., the largest value), such that the configuration that is altered is a configuration that resulted in a most favorable measure of the parameter from among one or more of the prior configurations. In this way, processor 202 may select an interim or then-best configuration, and alter 402 it to possibly achieve an even better configuration.

In some embodiments, an embodiment may further include processor 202 calculating 403 a first parameter produced by the altered 402 configuration. In some embodiments, the calculated 403 parameter may be calculated on a particular sample set (for example a set received from object database 208).

In some embodiments, altering 403 includes altering at least one of the group consisting of a hidden layer, a number of neurons at a layer, an activation function at a neuron, convolutional neural network, composition, fully connected neural network composition, pooling method at a layer, normalization method, stride, input layer size, and weight initializations.

In some embodiments, the calculated 403 first parameter is selected from the group consisting of a receiver operating characteristic curve, a confusing matrix, a true-positives rate and a false-positive rate, accuracy, Top-X error rate, or any other performance measurement.

In some embodiments, an embodiment may further include processor 202 calculating 404 a second parameter of a consecutive altered configuration of the at least two iterations. In some embodiments, at least one of the first parameter and second parameter may be stored on memory module 204.

In some embodiments, at least one consecutive altered configuration of the at least two iterations (e.g., consecutive to a previously calculated iteration) is based on a configuration generated by a prior iteration, said configuration generated by said prior iteration having a largest value of said first parameter from prior iterations. In some embodiments, a consecutive iteration may immediately follow a previous iteration. For example, it may be possible to calculate three iterations, where the parameter value of a first iteration is larger than the value of a second iteration so that the first iteration may be determined as having the largest value for comparison to the consecutive third iteration.

In some embodiments, an embodiment may include processor 202 comparing 405 values of the calculated first parameter and second parameter. For example, comparing 405 a calculated parameter for a first altered configuration with a calculated parameter for a second altered iteration of the configuration. In some embodiments, at least one of first altered configuration and second altered configuration may be stored on memory module 204 and/or on configuration database 209.

In some embodiments, an embodiment may include processor 202 determining 406 a configuration having largest value of the calculated parameters. In some embodiments, the determination 406 may be carried out by a processor. In some embodiments, the determination 406 may be carried out manually by the user.

It should be noted that while the final determination of the optimal configuration may be carried out manually, the processing and altering of the architectures of the neural network configurations cannot be carried out by a human user and must be carried out by a computerized processing unit (e.g., such as processor 202), due to the complexity and size of such networks.

In some embodiments, an embodiment may further include receiving a detection algorithm and determining an optimal configuration to correspond to the received detection algorithm so as to detect a predetermined object therewith.

In some embodiments, an embodiment may further include processor 202 automatically creating a detection algorithm based on a neural network with the determined configuration. In some embodiments, an embodiment may further include processor 202 automatically creating the detection algorithm. In some embodiments, an embodiment may further include processor 202 outputting the determined configuration.

In some embodiments, the selected neural network configuration may automatically create an object detection algorithm, by organizing nodes to function as such an algorithm, to detect objects (as output) based on input data received at the neural network 210, e.g. received at input layer 211 (as shown in FIG. 2B). Other algorithms may be created, for example by having network 210 organize itself to carry out or function as an algorithm.

As may be apparent to one of ordinary skill in the art, some known techniques manually modify a configuration of a deep network that has success in a specific learning task and then use that architecture to solve new learning tasks by changing some parameters (such as weights). In contrast, the method of automatically determining neural network configurations may provide automatic changes of the architecture of the deep network.

Unless explicitly stated, the method embodiments described herein are not constrained to a particular order in time or chronological sequence. Additionally, some of the described method elements can be skipped, or they can be repeated, during a sequence of operations of a method.

Various embodiments have been presented. Each of these embodiments can of course include features from other embodiments presented, and embodiments not specifically described can include various features described herein.

1. A method of determining a neural network configuration, the method comprising:
receiving, by a processor, at least one neural network configuration;
altering, by the processor, the received configuration for at least two iterations;
calculating, by the processor, a first parameter of the altered configuration;
calculating, by the processor, a second parameter of a consecutive altered configuration of the at least two iterations;
comparing, by the processor, values of the calculated first parameter and second parameter; and
determining, by the processor, a configuration having largest value of the calculated parameters.

2. The method as in claim 1, wherein the determined configuration defines a neural network to carry out an object detection algorithm.

3. The method as in claim 2, further comprising:
receiving a set of labeled samples;
performing evaluation of the received labeled samples with the object detection algorithm; and
detecting an object from the set of labeled samples, with the object detection algorithm.

4. The method as in claim 2, wherein the configuration is determined to correspond with an object to be detected with the object detection algorithm.

5. The method as in claim 2, further comprising outputting the object detection algorithm.

6. The method as in claim 1, wherein said parameter is selected from the group consisting of a receiver operating characteristic curve, a confusing matrix, real-time performance, a true-positives rate and a false-positive rate.

7. The method as in claim 1, wherein said altering is carried out randomly.

8. The method as in claim 1, further comprising outputting the determined configuration.

9. The method as in claim 1, wherein said altering comprises altering at least one of the group consisting of a hidden layer, a number of neurons at a layer, number of filters at each layer, type of network, an activation function at a neuron, convolutional neural network, composition, fully connected neural network composition, pooling method at a layer, normalization method, stride, input layer size, and weight initializations.

10. The method as in claim 1, wherein at least one consecutive altered configuration of the at least two iterations is based on a configuration generated by a prior iteration, said configuration generated by said prior iteration having a largest value of said first parameter from prior iterations.

11. A system for determining a neural network configuration, comprising:
a processor, configured to alter neural network configurations;
a memory module, coupled to the processor; and
a configuration database, coupled to the processor and configured to store neural network configurations;
wherein the processor is further configured to calculate parameters for each alteration of neural network configurations stored on the configuration database.

12. The system as in claim 11, wherein the memory module is configured to store a received set of labeled samples.

13. The system as in claim 11, further comprising an object database coupled to the processor and configured to provide input of objects therefor.

14. The system as in claim 11, further comprising at least one detector coupled to the processor and configured to detect objects.

15. The system as in claim 14, wherein the alteration of neural network configurations corresponds to objects detected by the at least one detector.

16. A method of determining a neural network configuration, the method comprising:
altering, by a processor, at least one neural network configuration;
calculating, by the processor, a first parameter of the altered configuration;
calculating, by the processor, a second parameter of different altered configuration;
comparing, by the processor, values of the calculated first parameter and second parameter; and
determining, by the processor, a configuration having largest value of the calculated parameters.

17. The method as in claim 16, wherein the determined configuration defines a neural network to carry out an object detection algorithm.

18. The method as in claim 17, further comprising:
receiving a set of labeled samples;
performing evaluation of the received labeled samples with the object detection algorithm; and
detecting an object from the set of labeled samples, with the object detection algorithm.

19. The method as in claim 17, wherein the configuration is determined to correspond with an object to be detected with the object detection algorithm.

20. The method as in claim 16, wherein said altering is carried out randomly.
